(19) United States
(12) Patent Application Publication
(10) Pub. No.: US 2003/0196861 A1
(43) Pub. Date: Oct. 23, 2003

(54) Extension socket device with a cord storage and dispensing system

(76) Inventor: Wang Han Yap, Melaka (MY)

Correspondence Address: MARTINE & PENILLA, LLP, 710 LAKEWAY DRIVE, SUITE 170, SUNNYVALE, CA, 94085, US

(21) Appl. No.: 10/418,760

(22) Filed: Apr. 18, 2003

(30) Foreign Application Priority Data
Apr. 18, 2002 (MY) PI 20021435

(51) Int. Cl. H02G 11/00

(52) U.S. Cl. 191/12 R

(57) ABSTRACT

There is disclosed an extension socket device, electrically equipped with a plurality of socket units and a cord storage and dispensing system. The present invention comprises a rectangular housing body formed by two hollow parts, an electrical plug and an extension cord. The larger hollow part of the housing body comprises a top wall, two end walls and two side walls. The smaller hollow part comprises a ring-like intermediate wall and a bottom wall, wherein the intermediate wall and the bottom wall integrally form a working enclosure defining a working space for the wiring mechanism of the socket units. A receiving track of predetermined space is formed when the larger hollow part and the smaller hollow part are assembled together. The extension cord of predetermined length in single file is fully retracted into the receiving track. A plurality of flexible retainer means is integrally provided along the bottom edge of the smaller hollow part. Each retainer means covers partially the opening of the receiving track. The cord storage and dispensing system comprises the receiving track and the flexible retainer means.

### TECHNICAL FIELD

This invention relates generally to extension socket devices, and particularly to an extension socket device with a cord storage and dispensing system.

### BACKGROUND ART

Extension socket can provide multiple socket units for more than one electrical appliance to share the power source from a common wall socket or any extension socket. Prior art extension socket device comprises a housing body with multiple socket units, an electrical plug, and an elongated extension cord connecting the plug and the housing body. The length of the extension cord is often left exposed and can be entangling.

U.S. Pat. No. 6,142,405 discloses an extension cord storage and dispensing system for conveniently storing and dispensing an elongated extension cord of various lengths without entanglement and without requiring the unwrapping of the entire length of extension cord to effectively utilise both ends. The inventive device includes a second spool, a first spool and a handle. The two spools have preferably a flat profile for convenient storage. The first spool receives a longer length of the extension cord while the second spool receives a shorter length of the cord that is commonly needed thereby separating the shorter length constantly dispensed and stored from the longer length. The main disadvantage of this invention is that it is a stand-alone device which is not directly connected to any electrical device. In actual application, it becomes an additional carrying item.

U.S. Pat. No. 6,077,109 discloses an extension socket, including a socket body which consists of more than one socket units electrically connected each other, an electrical plug, an extension wire having a predetermined length connecting between the socket units and the electrical plug, and a receiver arrangement for receiving the extension wire. The socket body includes a socket housing to install the socket units therein. The socket housing has a top wall, a bottom wall and a surrounding side wall between the top wall and the bottom wall, wherein the extension wire is extended from a wire outlet of the surrounding side wall to the electrical plug. The receiver arrangement is composed of a ring shaped protecting wall which is arranged to surround the socket housing of the socket body and has a predetermined height, and a connecting wall extended from a top end of the protecting wall to the socket housing, wherein a receiving chamber is defined between the protective wall and the surrounding side wall of the socket housing. Thereby, the extension wire can be wound around the surrounding side wall of the socket housing within the receiving chamber. The main disadvantage of this invention is that a separate receiver arrangement surrounding the socket body is required. The holding arm is also not efficient.

### SUMMARY OF THE INVENTION

The present invention has therefore as an object to equip an extension socket device integrally with a cord storage and dispensing system, without increasing its construction cost.

A further object of the invention is to provide a plurality of flexible retainer means along a smaller hollow part of a housing body. Each retainer means partially covers the opening of a receiving track, such that the movement of an extension cord is restrained.

These objects are achieved in that the housing body of the above extension socket device is provided integrally with the receiving track with sufficient space to accommodate the extension cord in single file.

### BRIEF DESCRIPTION OF THE DRAWINGS

In order that the present invention may be more readily understood, the following description is given, by way of example, of one specific embodiment of an extension socket device made in accordance with this invention. Reference is made to the accompanying drawings, in which:

FIG. 1 is a perspective view showing the front of an extension socket device with an extension cord extended for use.

FIG. 2a is a plan back view of this invention, without the extension cord.

FIG. 2b shows in perspective the retracted position of the extension cord in single file, withdrawn from its actual position inside a receiving track of a housing body.

FIG. 3a shows diagrammatically the relative position of the extension cord in single file when retracted inside the receiving track of the housing body.

FIG. 3b shows an exploded perspective view of a flexible retainer means.

### DETAILED DESCRIPTION

Like the prior art extension socket device, a substantially rectangular housing body (10) of this invention essentially is formed by two hollow parts (10a, 10b). The larger hollow part (10a) comprises a top wall (11), two end walls (12) and two side walls (13). The smaller hollow part (10b) comprises a ring-like intermediate wall (17) and a bottom wall (14). For ease of explanation, the larger hollow part (10a) is placed over the smaller hollow part (10b). The terms “top” and “bottom” are used according to this orientation. However, other orientations of the housing body (10) are possible.

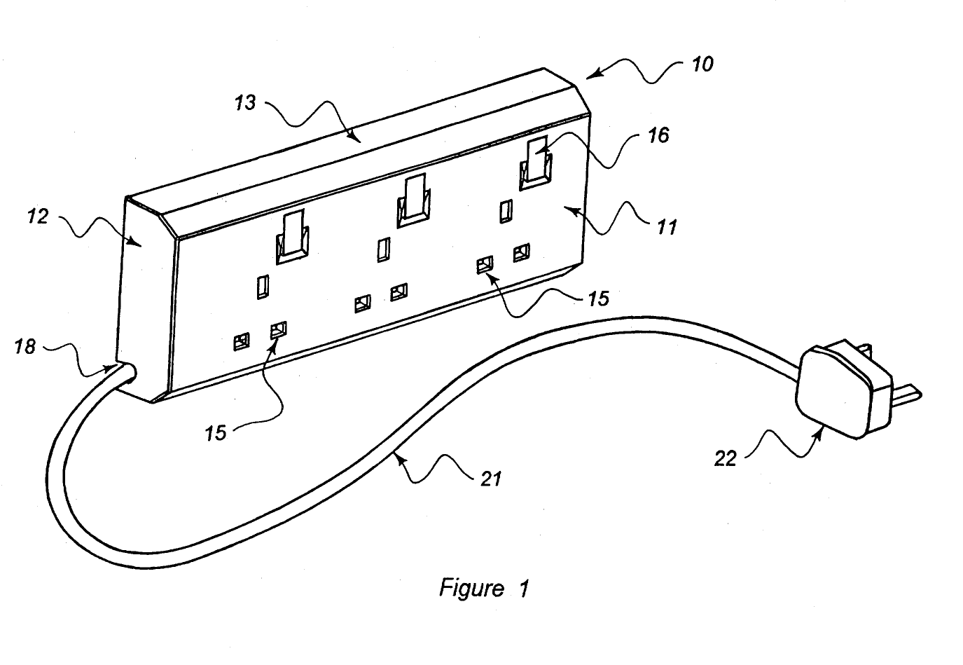

A gang of three socket units (15) are provided on the top wall (11) of the rectangular housing body (10), as seen in FIG. 1. Each socket unit (15) is operable from a switch (16). An extension cord (21) with an electrical plug (22) is fully extended from an outlet port (18) on one end wall (12) of the housing body (10).

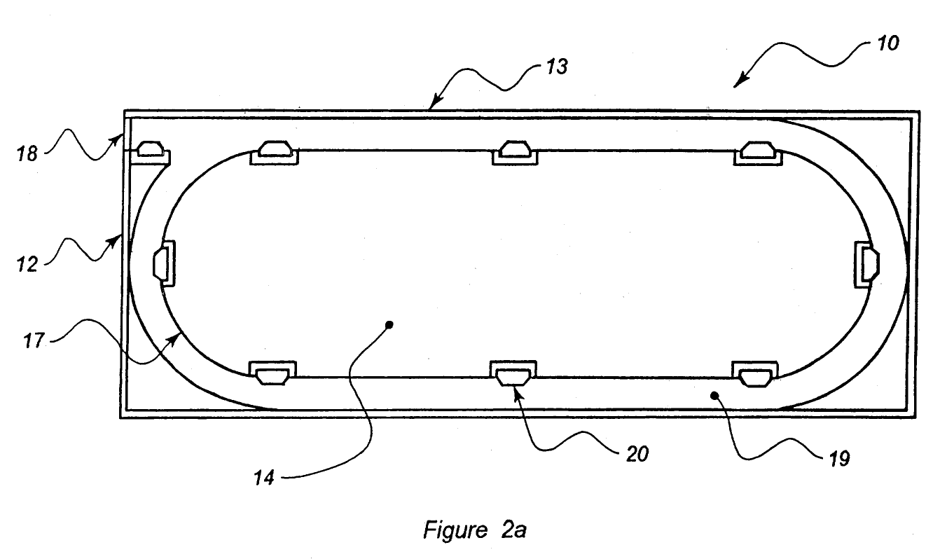

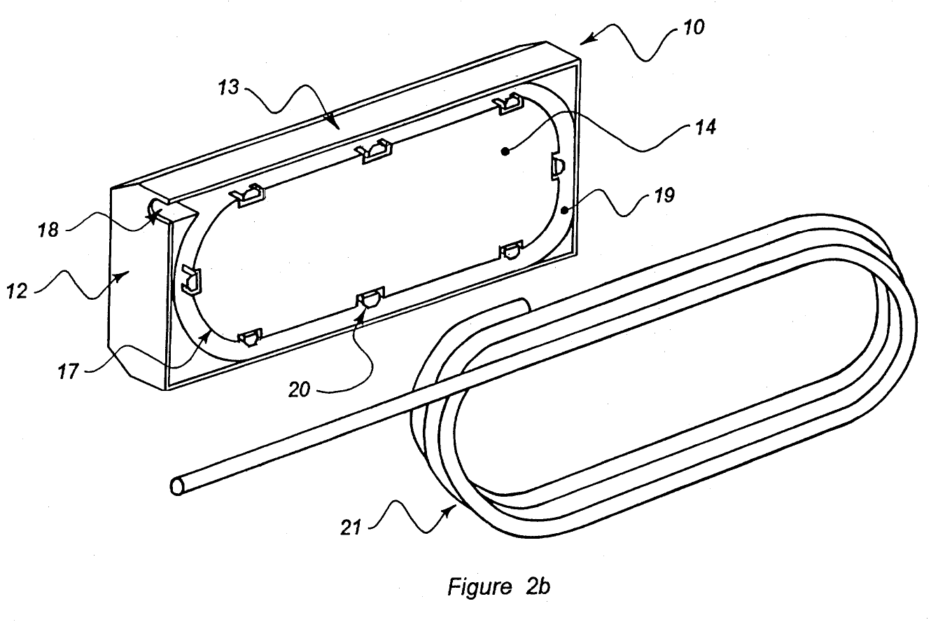

At the back of the rectangular housing body (10) as seen in FIG. 2a, the smaller hollow part (10b) of the housing body (10) defines a working enclosure, with a working space for the wiring mechanism of the socket units (15). An exit port (not seen) is also provided on the intermediate wall (17), for one end of the extension cord (21) to electrically connect to the wiring mechanism inside. A receiving track (19) is thus formed between the larger hollow part (10a) and the smaller hollow part (10b) of the housing body (10) when they are assembled together. The receiving track (19) takes the form of an open ring-like trough. At predetermined positions along the bottom edge of the smaller hollow part (10b), there is provided a plurality of flexible retainer means (20). Each retainer means (20) partially covers the opening of the receiving track (19). The retainer means (20) serves to restrain the movement of the extension cord (21) in single file when it is retracted inside the receiving track (19).

Referring to FIG. 2b, one end of the extension cord (21), in single file when it is fully retracted inside the receiving track (19), connects electrically to the wiring mechanism inside the working enclosure, through the exit port provided on the intermediate wall (17) of the smaller hollow part (10b). The width of the receiving track (19) is designed in such a way that there is sufficient space for a single file of the extension cord (21). This helps to restrain the movement of the extension cord (21). The extension cord (21) is wound round the perimeter of the working enclosure several times. Depending on the predetermined depth of the receiving track (19) according to the design of the invention, predetermined rounds or complete turns of the extension cord (21) are allowed. In FIG. 2b, four turns are shown. The other end of the extension cord (21) is disposed outermost to the housing body (10). An outlet port (18) is integrally provided at one end wall (12) of the larger hollow part (10a), to allow this other end of the extension cord (21) to exit from the housing body (10), and connectable to an electrical plug (22).

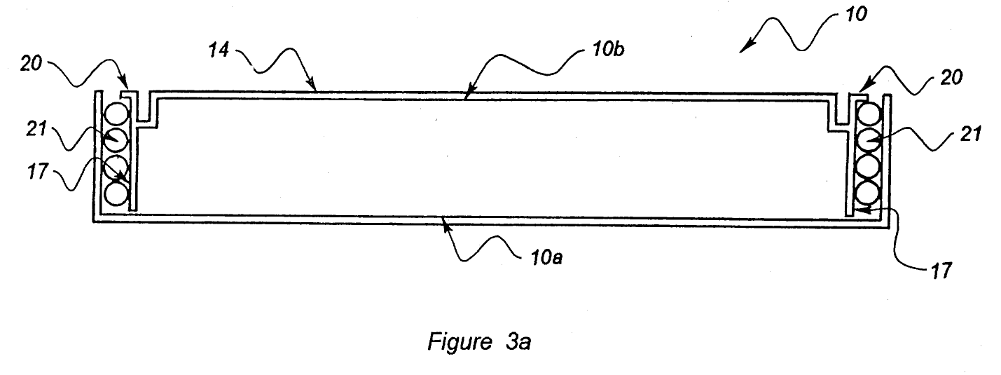

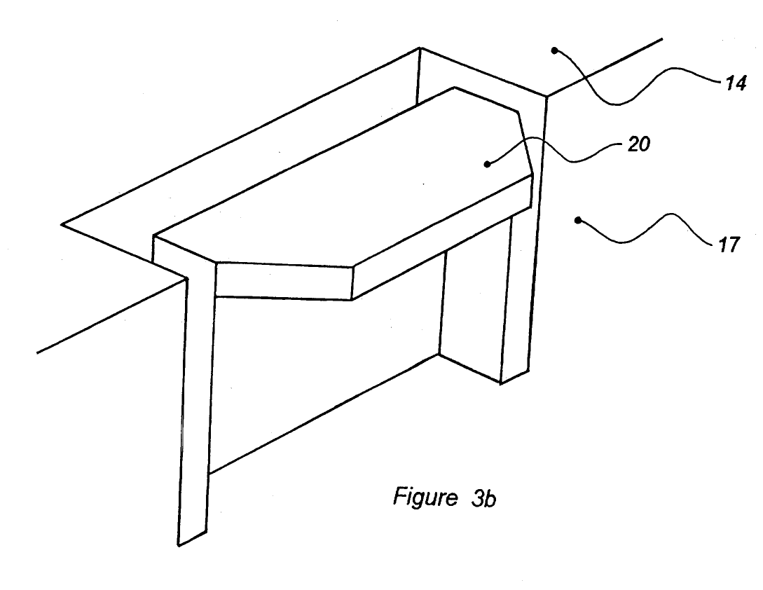

As clearly seen in FIG. 3a, the receiving track (19) is defined by the larger and smaller hollow parts (10a, 10b) of the housing body (10). Four turns of the extension cord (21) are retracted into the receiving track (19), one on top of the other in single file. A plurality of flexible retainer means (20) takes the form of an inverted L-shaped element integrally provided along the bottom edge of the smaller hollow part (10b). The horizontal arm of the L-shaped element covers partially the opening of the receiving track (19). As seen in FIG. 3b, space is also provided between the inverted L-shaped element and the intermediate wall (17), wherein a slight flexibility is allowed. In other words, the flexible retainer means (20) are integrally moulded as structural features of the smaller hollow part (10b) of the housing body (10). The receiving track (19) and the flexible retainer means (20) therefore constitute a cord storage and dispensing system for the present invention.

What is claimed is:

1) An extension socket device, electrically equipped with a plurality of socket units and a cord storage and dispensing system, comprises a rectangular housing body formed by two hollow parts, an electrical plug and an extension cord wherein the larger hollow part of the rectangular housing body comprises a top wall, two end walls and two side walls;
the smaller hollow part comprises a ring-like intermediate wall and a bottom wall, wherein the smaller hollow part contains a working enclosure defining a working space for the wiring mechanism of the socket units,
is characterised in which
a receiving track of predetermined space is formed between the larger hollow part and the smaller hollow part when assembled; and a plurality of flexible retainer means is integrally provided along the bottom edge of the smaller hollow part;
whereby the extension cord of predetermined length in single file can be fully retracted into the receiving track.

2) An extension socket device with a cord storage and dispensing system as in claim 1 wherein the predetermined length of the extension cord depends on the number of turns around the perimeter of the working enclosure.

3) An extension socket device with a cord storage and dispensing system as in claim 1 wherein the flexible retainer means takes the form of an inverted L-shaped element integrally provided along the bottom edge of the smaller hollow part (10b), wherein the horizontal arm of the L-shaped element covers partially the opening of the receiving track, and space is also provided between the inverted L-shaped element and the intermediate wall.

4) An extension socket device with a cord storage and dispensing system as in claim 1 wherein the cord storage and dispensing system comprises the receiving track and the flexible retainer means.

5) An extension socket device with a cord storage and dispensing system as in claim 1 wherein the flexible retainer means are integrally moulded as structural features of the smaller hollow part of the housing body.
